(19) United States
(12) Patent Application Publication
(10) Pub. No.: US 2010/0094241 A1
(43) Pub. Date: Apr. 15, 2010

(54) DEVICE FOR TRANSFERRING A SUBSTANCE BETWEEN CONTAINERS

(76) Inventors: Axel Remde, Lutzelfluh-Goldbach (CH); Rudolf Zihlmann, Langnau (CH)

Correspondence Address: Dorsey & Whitney LLP, IP Department, ATTN: Disetronic Licensing AG, 50 South Sixth Street, Suite 1500, Minneapolis, MN, 55402-1498, US

(21) Appl. No.: 12/511,315

(22) Filed: Jul. 29, 2009

Related U.S. Application Data
(63) Continuation of application No. PCT/EP2007/008929, filed on Oct. 15, 2007.

(30) Foreign Application Priority Data
Jan. 30, 2007 (EP) 07 101 408.8

(51) Int. Cl. A61J 1/20; B65B 3/04

(52) U.S. Cl. 604/403; 141/25

(57) ABSTRACT

A transfer device for use in transferring a substance from a storage container into an ampoule that can be inserted into a device for dosed administration of substance, the transfer device including an adapter for securing the storage container and the ampoule relative to each other and coupling them to be able to transfer a substance contained in the storage container into the ampoule, and a displacement element that can act on the storage container such that the substance contained in the storage container is forced out of the storage container and transferred into the ampoule via the coupling formed by the adapter.

### CROSS-REFERENCE TO RELATED APPLICATIONS

This application is a continuation of International Patent Application No. PCT/EP2007/008929, filed on Oct. 15, 2007, which claims priority to European Application No. 07 101 408.8, filed on Jan. 30, 2007, the entire contents of both of which are incorporated herein by reference.

### BACKGROUND

The present invention relates to devices for injecting, administering, infusing, dispensing or delivering a substance, and to methods of making and using such devices. More particularly, it relates to peripheral or auxiliary devices for use in association and/or conjunction with devices for injecting, administering, infusing, dispensing or delivering a substance, and to methods of making and using such peripheral or auxiliary devices. More particularly, it relates to a device for transferring a substance, e.g. a medicine such as insulin or a hormone, from one container to another, for example a container or ampoule usable in an injection device or insulin pump can be filled from a purchased ampoule or from another container or reservoir containing the substance.

Devices for transferring medicines from one container to another, mostly using what are called disposable syringes, have been known for a long time. Basically, the cannula of a disposable syringe is pushed through a pierceable membrane of a normal or customary medicine container, and a medicine is removed by suction from the medicine container through the cannula and into the disposable syringe.

The same transfer procedure is also the basis for filling a disposable ampoule which is to be used in an infusion pump or an injection device, e.g. an injection pen. Such infusion pumps are known, for example, from EP 0 143 895. Injection pens are known, for example, from WO 87/02895. Disposable ampoules differ from disposable syringes in that the stopper is not designed to be pushed forward manually but instead to be coupled to an electro-mechanical drive mechanism.

The disposable ampoules provided for use in infusion pumps are in most cases filled from a rigid storage container, which is provided with a pierceable membrane and has a much greater capacity than the disposable ampoule. Capacities of about 10 ml for the storage container and 3 ml for the disposable ampoule are typical. For the patient, however, the procedure of transferring a medicine from one container to another in a sterile manner, and without formation of bubbles, is an awkward one and is susceptible to errors. The transfer procedure proves much easier from what is called a pen ampoule, which contains a quantity of medicine comparable to the filling volume of the disposable ampoule. The pen ampoule is provided at one end with a pierceable membrane and at the other end with a displaceable stopper, and the medicine can be forced out of the cylindrical ampoule body by displacement of the stopper, in a manner similar to a syringe. The disposable ampoule is provided at one end with a pierceable membrane or a fluidic connector, e.g. in the form of a male Luer connector. At the other end, the volume of medicine is closed off, in a manner comparable to a syringe, by a displaceable stopper which, upon use in the infusion pump, is coupled to the drive mechanism of the latter.

DE 299 15 878 U1 discloses a device for transferring medicines comprising a container, the rear end or opening of which can be closed by a movable stopper connected to a piston rod and the other end or front opening of which leads into a first cannula, wherein a second cannula is arranged along with the first cannula.

### SUMMARY

It is an object of the present invention to provide a device for transferring a substance, e.g., a medicine, from one container to another, wherein the device can be easily operated by a user and simplifies the transfer of the substance.

In one embodiment, the present invention comprises a device for transferring a substance, for example a pharmaceutical product or medicine such as insulin or a solution containing hormones, from a storage container into an ampoule, for example an insulin pump cartridge, that can be inserted into a pump, wherein the device comprises an adapter and/or holder for orienting and securing and/or for fixing and coupling the storage container and the ampoule relative to each other.

In one embodiment, the present invention comprises a transfer device for use in transferring a substance from a storage container into an ampoule that can be inserted into a device for dosed administration of the substance, the transfer device comprising an adapter for securing the storage container and the ampoule relative to each other and coupling them to be able to transfer a substance contained in the storage container into the ampoule, and a displacement element that can act on the storage container such that the substance contained in the storage container is forced out of the storage container and transferred into the ampoule via the coupling formed by the adapter.

In one embodiment, the present invention comprises a method of transferring a substance, for example a pharmaceutical product or medicine such as insulin or a solution containing hormones, from a storage container into an ampoule, for example an insulin pump cartridge, that can be inserted into a pump, wherein the method involves providing an adapter and/or holder, orienting and securing and/or fixing and coupling the storage container and the ampoule relative to each other using the adapter and/or holder, and transferring the substance from the storage container to the ampoule.

In some preferred embodiments, the adapter has a guide element or a holder for the storage container, for example the pen ampoule, and for the ampoule that is to be filled, such that these two containers or ampoules can be oriented relative to each other and can be fixed or held in the oriented position. For this purpose, a guide element of the adapter can be designed as a jacket that projects partially over the ampoule or over an end of the ampoule. It is also possible to design the adapter in such a way that the ampoules are oriented and fixed or secured relative to each other such that a guide or holder for orienting the respective container or the respective ampoule is provided at the inlet opening or outlet opening thereof Furthermore, the transferring device has a displacement body or ram which can be pushed or guided into the storage or discharge container and with which, for example, a stopper can be pushed into the storage container or into the storage ampoule.

In some preferred embodiments, the adapter according to the present invention thus has a holder or holders for the storage container, for example a pen ampoule, and for the container that is to be filled, for example a pump ampoule, and the holders are advantageously designed such that at least ⅕ of the axial length of the respective container or of the respective ampoule can be enclosed or held. Generally, the term “adapter” within the meaning of the invention is to be understood as an element which orients or positions and/or holds two objects, e.g. two ampoules or containers, relative to each other.

In some embodiments, an adapter in accor with the present invention can be designed such that the adapter by itself does not produce a fluidic coupling of the containers or ampoules, and the containers or ampoules, for example, are oriented in a desired arrangement relative to each other, for example coaxially with respect to each other, by suitable guide webs or guide projections. The containers or ampoules can then be coupled, for example by a cannula that is known per se and that can be mounted on an ampoule for transferring the substance from one container to another.

In one embodiment, the adapter, for positionally correct orientation of ampoules, can be designed as an element which can be folded open in the longitudinal direction and into which the ampoules are placed such that the openings lie opposite one another. The ampoules can be already coupled fluidically at this stage, or they may be coupled thereafter using a coupling piece, for example. The adapter can then be closed to fix the ampoules in their inserted position and to carry out the transfer of fluid, for example with the aid of a ram.

To allow the transfer of fluid to take place uniformly, in some embodiments the adapter can be provided with a spring element which, for example, is tensioned by pulling out the ram. After the ampoules have been inserted and positioned, the ram, which may be locked in a withdrawn position, can be released or let go, such that the ram is pressed into the ampoule by the force of the pretensioned spring, thereby to effect a uniform transfer of the fluid into the ampoule that is to be filled.

For uniform transfer of the liquid or fluid, the ram can also be connected to the adapter by a threaded coupling, such that the ram has to be screwed into the adapter to carry out the transfer of fluid, thereby avoiding an abrupt or rapid and non-uniform transfer of the fluid.

In some embodiments, a gas or air separator membrane can optionally be provided in a coupling piece for the fluid transfer to ensure that air contained in the ampoule along with substance to be discharged is not transferred into the ampoule that is to be filled. Air separator membranes or air filters that are permeable to gas or air but impermeable to fluid are known in the prior art.

In some embodiments, the storage containers or ampoules are prefabricated with an adapter already fitted thereon. A set of ten storage containers or ampoules, for example, each fitted with an adapter, can be provided with a single ram that can be used a number of times.

According to one embodiment of the present invention, the adapter has at least one catch element to lock the adapter to the ampoule holder and at least one catch element to lock the adapter to the ampoule that is to be filled, on which corresponding mating catch elements can be provided at the discharge opening.

For hygiene reasons and to comply with regulations, the adapter should be designed as a disposable part.

### BRIEF DESCRIPTION OF THE DRAWINGS

FIG. 1 shows the arrangement of ampoules or containers in an initial state, when using one embodiment of the transferring device in accordance with the present invention;

FIG. 2 shows the ampoule arrangement of FIG. 1 in an end state;

FIG. 3 shows an embodiment of a transferring device that can be folded open;

FIGS. 4 and 5 show embodiments of holders for the ampoules;

FIG. 6 shows a detail of the rear end of a transferring device; and

FIGS. 7 to 9 show embodiments of the front end of a device for transferring substances between ampoules.

### DETAILED DESCRIPTION

With regard to fastening, mounting, attaching or connecting components of the present invention, unless specifically described as otherwise, conventional mechanical fasteners and methods may be used. Other appropriate fastening or attachment methods include adhesives, welding and soldering, the latter particularly with regard to the electrical system of the invention, if any. In embodiments with electrical features or components, suitable electrical components and circuitry, wires, wireless components, chips, boards, microprocessors, inputs, outputs, displays, control components, etc. may be used. Generally, unless otherwise indicated, the materials for making the invention and/or its components may be selected from appropriate materials such as metal, metallic alloys, ceramics, plastics, etc. Unless otherwise stated, terms of relative position or orientation, e.g., front and rear, up and down, etc., are used to describe, not to limit.

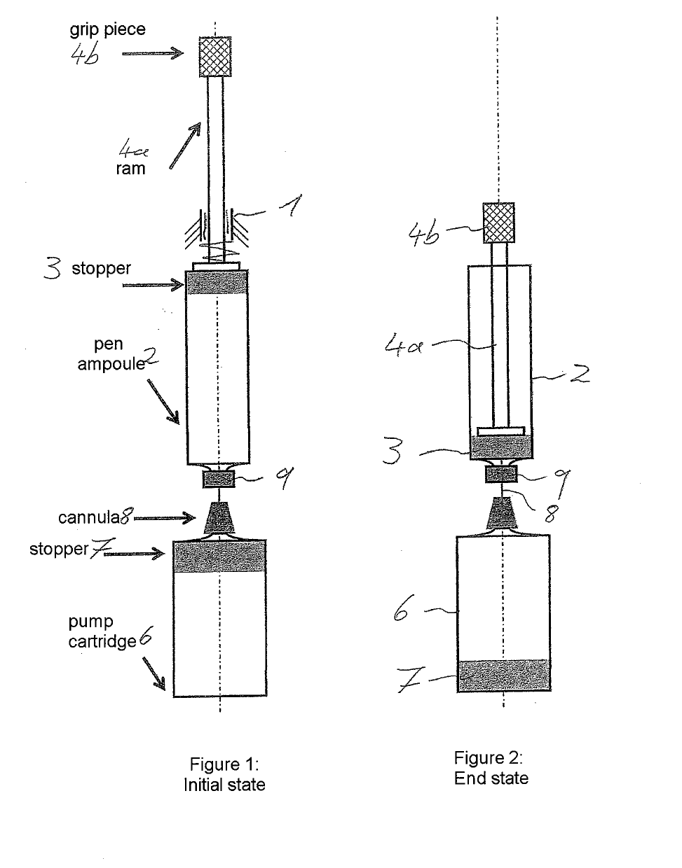

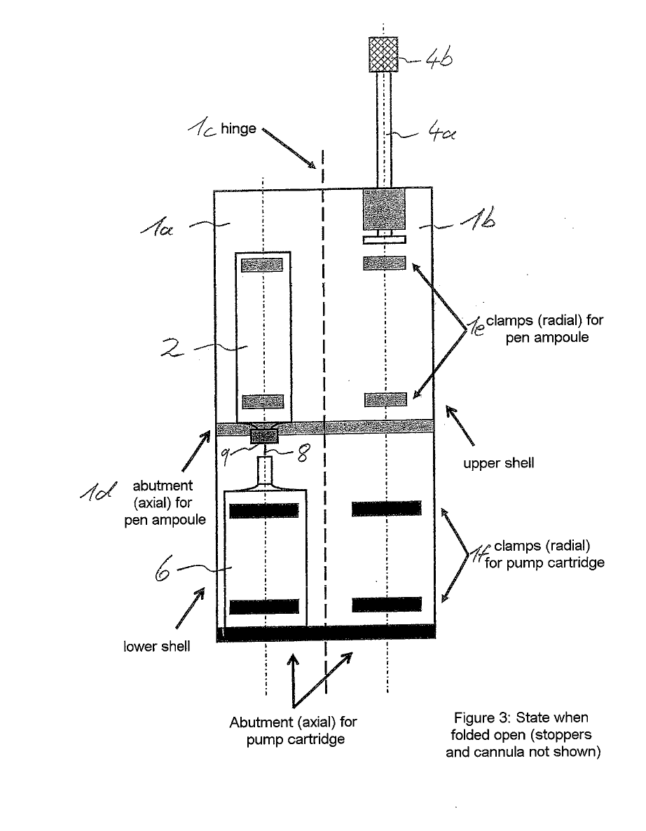

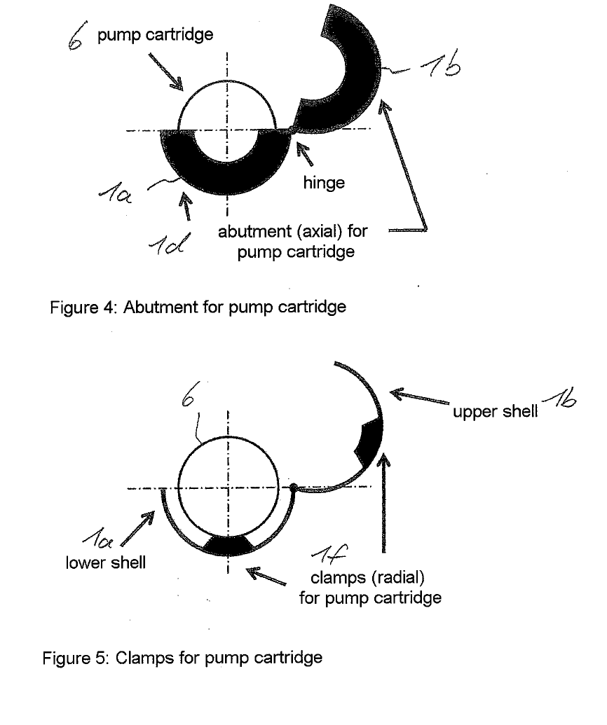

FIG. 1 and FIG. 2 show an arrangement of ampoules held by a transferring device 1, where a substance is to be transferred from a pen ampoule 2 into an insulin ampoule or insulin pump cartridge 6, in the initial state and end state, respectively, i.e. before and upon completion of a transfer procedure. The transferring device, also described below with reference to FIG. 3, holds the ampoules 2, 6 securely in the illustrated position relative to each other, for example after insertion of the empty ampoule 6, with a cannula 8 provided at the inlet and discharge opening, and after insertion of the filled ampoule 2, with a septum 9 at the discharge opening. In the embodiment shown, the ampoules 2 and 6 are arranged coaxially with respect to each other and are held in the illustrated arrangement by, for example, holding elements, abutments 1d and/or clamps 1f of the transferring device 1, as is described below with reference to FIGS. 4 and 5.

A ram 4a, which can be actuated by a user and which comprises a grip piece 4b, can be pushed into the transferring device 1 and presses with its front end onto a stopper 3 which is displaceable in the ampoule 2, so that the ampoule 2 can be emptied. The substance contained in the ampoule 2 can be transferred, via the fluidic connection formed by the cannula 8 inserted into the septum 9, into the ampoule 6 that is to be filled, in which process the stopper 7 of the ampoule 6 is pushed to the rear end of the ampoule 6 during the transfer procedure, as is shown in FIG. 2.

After the transfer procedure has been completed, the ampoules 2 and 6 can be removed from the transferring device 1.

FIG. 3 is a schematic plan view of a transferring device 1 which is folded open and into which the ampoules 2 and 6 are placed, and after the fluidic connection between the ampoules has been produced by inserting the cannula 8 of the ampoule 6 into the septum 9 of the ampoule 2. The transferring device 1 is composed of two semi-cylindrical shells 1a and 1b, which are connected pivotably to each other via a hinge 1c. Axial abutments 1d and radial clamps 1e, 1f, for example ribs, may be provided for holding the ampoules 2 and 6 when the shells 1a, 1b are folded together. The ampoules 2 and 6 are placed into the transferring device 1 with the latter folded open. For the actual transfer procedure, the shells 1a and 1b are folded together by a user, the folding procedure being shown in an axial plan view in FIGS. 4 and 5. The shells 1a and 1b folded together can be held closed in one hand by a user, the ampoules 2, 6 being fixed or clamped, while the ram 4a can be pushed into the transferring device 1 using the other hand to transfer substance between the ampoules.

In some embodiments, to permit visual monitoring or checking of the transfer procedure, one or both of the shells 1a, 1b of the transferring device 1 can be made completely or partially of a transparent material. Likewise, cuttings, openings or slits can be formed in one or both of the shells 1a, 1b to allow the transfer procedure to be checked or monitored by sight. In some embodiments, the adapter may have a transparent portion or openings for checking or monitoring the amount of the substance to be transferred in one or both of the storage container and the ampoule.

In addition to the arrangement shown, variants or other embodiments are possible. For example three or more clamping ribs 1f may be used, which are then each arranged at an angle of, for example, 120° to one another. Also, instead of the shells 1a, 1b being held together by hand, this could be done by, for example, a releasable catch or a snap-fit closure. The ram 4a could also be designed as a spindle with an outer thread, while the spindle guide, which, for example, could be part of the transferring device 1 or of a shell 1a, 1b, comprises an inner thread. In this case, the transfer procedure could be carried out very precisely by a rotational movement of the ram 4a. Another alternative involves using a spring drive, in which case, for example, the ram 4a is pushed or screwed into the transferring device 1 by a tensioned spring.

Instead of using a cannula 8 for coupling the ampoules 2, 6, it would also be possible to use an adapter or coupling part with integrated air separator. In this way, the air present in the pen ampoule 2 is automatically removed during the transfer procedure. By a suitable mechanical arrangement, it would also possible to couple a filling aid to the pump and to use the motor movement of the pump drive, or the motor return of the threaded rod of the pump, for the transfer procedure.

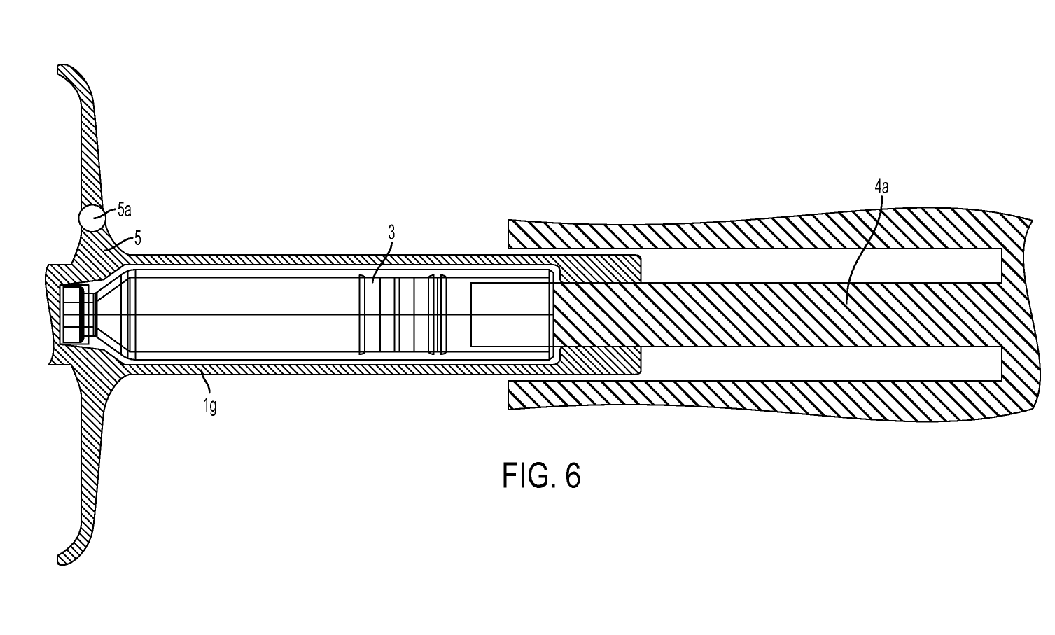

FIG. 6 shows another embodiment of a transferring device 1 comprising an ampoule holder 1g into which the ampoule 2 containing the substance to be transferred is placed.

The ampoule 2 depicted in FIG. 6 again has a displaceable stopper 3 to displace the substance contained in the ampoule 2. A further component is a ram 4a which is coupled to the ampoule holder 1g and which is pushed onto the ampoule holder 1g or pushed into the latter such that a rod mounted on the ram 4a and acting on the stopper 3 pushes the stopper 3 into the ampoule 2, when the ram 4a is inserted into the ampoule holder 1, and thus displaces and discharges the substance out of the ampoule 2. An adapter 5 is provided as a third element, onto which an adapter shoulder 5a is fitted. The adapter 5 couples the discharge opening or outlet of the ampoule 2 to the opening of the ampoule 6 that is to be filled, such that, during displacement of the stopper 3 in the ampoule 2 containing the substance to be discharged, this substance can pass through the adapter 5 and into the ampoule 6 that is to be filled.

It is also possible in principle to integrate the adapter 5 into the ampoule holder 1, although the use of a separate adapter 5 may be preferred in some embodiments since, for hygiene reasons, for example, a needle 8 provided on the adapter 5 and to be inserted into the ampoule 6 to be filled and/or into the ampoule 2 to be emptied should be used only once.

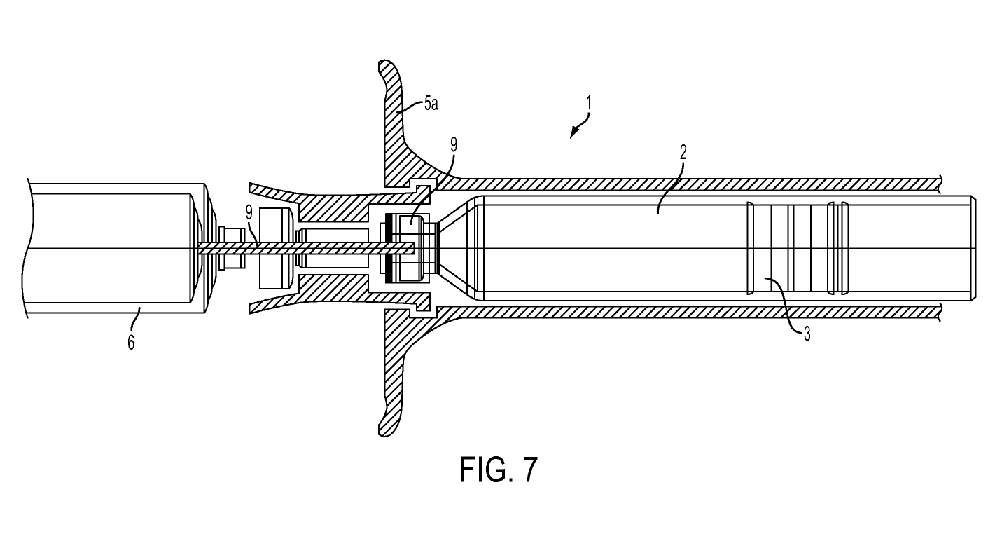

FIGS. 7 to 9 show various embodiments of the coupling of the ampoule 6 to be filled to the transferring device 1 or to the ampoule 2 containing the substance to be transferred.

FIG. 7 shows an exemplary embodiment of a transferring device 1 wherein the ampoule 6 which is to be filled, and which is made of plastic, is coupled fluidically to the pen ampoule 2 by a cannula 8 which is connected to the ampoule 6 to be filled and which is pushed through a septum 9 of the pen ampoule 2, to thereby create a fluidic connection between the interior of the two ampoules.

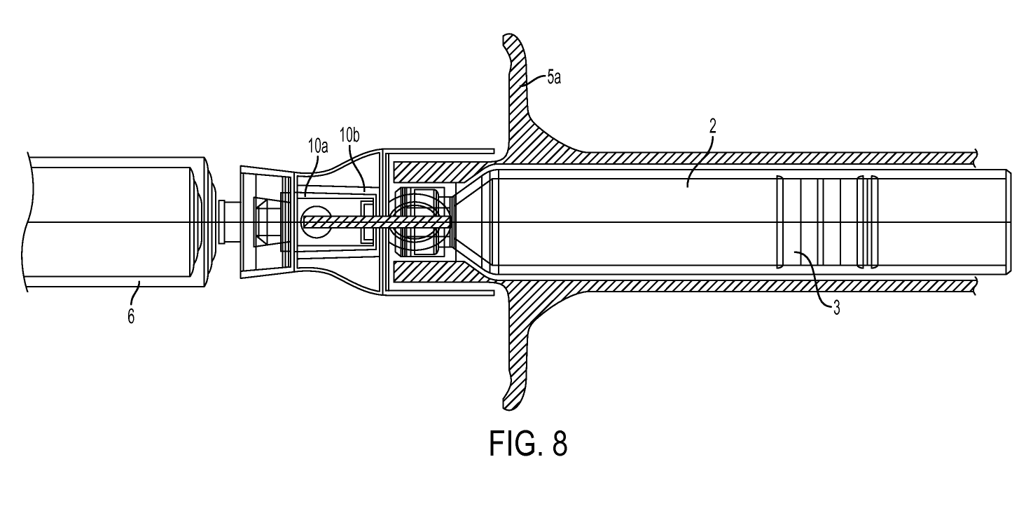

FIG. 8 shows another embodiment of a coupling of the ampoules 2 and 6 wherein the ampoule 6 to be filled has a male Luer connector 10a, which is connected to a female Luer connector 10b of the pen ampoule 2 to produce the fluidic connection between the ampoules 2 and 6.

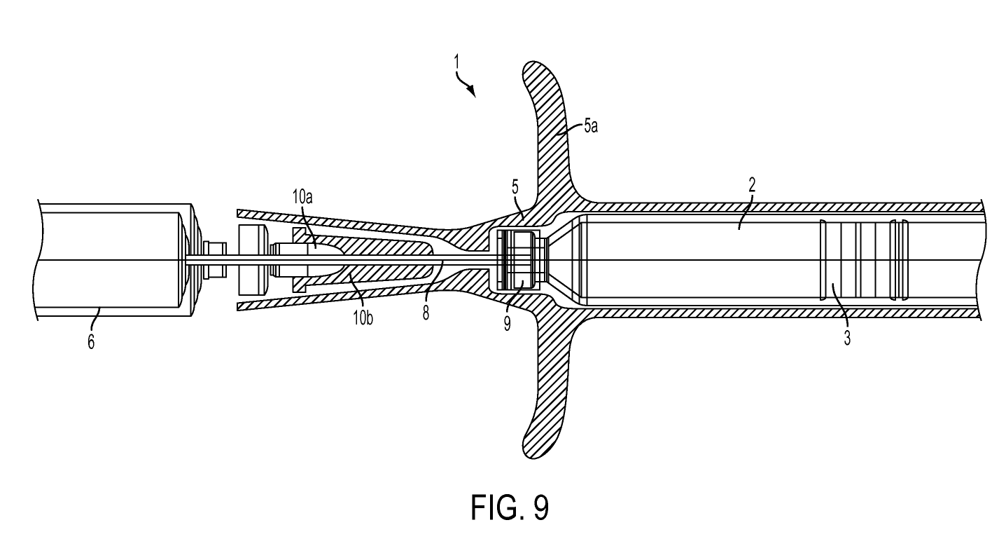

FIG. 9 shows another embodiment of a transferring device 1 in which an adapter 5 is fitted onto a male Luer connector 10a of the ampoule 6 that is to be filled, the adapter 5 being composed of a female Luer connector 10b into which a cannula 8 is inserted that can be pushed through a septum 9 of the pen ampoule 2.

Embodiments of the present invention, including preferred embodiments, have been presented for the purpose of illustration and description. They are not intended to be exhaustive or to limit the invention to the precise forms and steps disclosed. The embodiments were chosen and described to provide the best illustration of the principles of the invention and the practical application thereof, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

1. A transfer device for use in transferring a substance from a storage container into an ampoule that can be inserted into a device for dosed administration of the substance, the transfer device comprising an adapter for positioning and securing the storage container and the ampoule relative to each other and operably coupling them for transferring a substance contained in the storage container into the ampoule, and a displacement element for acting on the storage container such that the substance contained in the storage container is forced out of the storage container and transferred into the ampoule via the operable coupling.

2. A transferring device for transferring a substance from a storage container into an ampoule that can be inserted into a device for dosed discharge of the substance, the transferring device comprising an adapter for securing the storage container and the ampoule relative to each other and coupling them so that a substance contained in the storage container can be transferred into the ampoule, and a displacement element able to act on the storage container whereby the substance contained in the storage container can be displaced from the storage container and transferred to the ampoule via the coupling obtained by the adapter.

3. The transferring device according to claim 2, wherein the displacement element is a ram which can be moved relative to the transferring device to push on a stopper associated with the storage container.

4. The transferring device according to claim 2, wherein the displacement element is an element which can be moved relative to the transferring device to deform the storage container.

5. The transferring device according to one claim 2, wherein the adapter further comprises a male Luer connector, a female Luer connector and a cannula to couple the storage container and the ampoule.

6. The transferring device according to claim 2, wherein the adapter further comprises at least one guide element to ensure that the storage container and the ampoule are oriented relative to the adapter and to each other in a defined position.

7. The transferring device according to claim 6, wherein the guide element comprises a catch element.

8. The transferring device according to claim 3, wherein the ram is guided on or in the adapter.

9. The transferring device according to claim 4, wherein the displacement element is guided on or in the adapter.

10. The transferring device according to claim 2, further comprising at least one or two shells into which at least one of the storage container and the ampoule can be placed.

11. The transferring device according to claim 2, further comprising a foldable element that can be foldably opened and closed, wherein, when opened, at least one of the storage container and the ampoule can be placed in the foldable element, and wherein, when closed, the at least one of the storage container and the ampoule is fixed relative to the transferring device.

12. The transferring device according to claim 2, further comprising one of a transparent portion or viewing slits for monitoring the amount of substance in at least one of the storage container and the ampoule.

13. The transferring device according to claim 2, wherein the adapter comprises one of a transparent portion or viewing slits for monitoring the amount of substance in at least one of the storage container and the ampoule.

14. The transferring device according to claim 2, wherein the ram is a spindle or has a thread.

15. The transferring device according to claim 14, wherein the ram is driven by a spring drive or is coupled to a motor of a pump for the dosed administration of the substance.

16. The transferring device according to claim 2, further comprising an air-permeable element in the area of the coupling to separate off gas contained in the substance.

17. The transferring device according to claim 2, wherein the adapter comprises an air-permeable element in the area of the coupling to separate off gas contained in the substance.
